(19) United States
(12) Patent Application Publication
(10) Pub. No.: US 2008/0062247 A1
(43) Pub. Date: Mar. 13, 2008

(54) Transmission of image for telephone, computer PC, laptop

(76) Inventor: Henri Duong, Alhambra, CA (US)

Correspondence Address: Henri Duong, 316 1/2 E Glendon way, Alhambra, CA, 91801, US

(21) Appl. No.: 11/511,897

(22) Filed: Aug. 28, 2006

(51) Int. Cl. H04N 7/14

(52) U.S. Cl. 348/14.01

(57) ABSTRACT

Telephone has no facilities for us to see each other during calling. Image Screen Telephone is invented having image transmitted letting caller and call receiver talking face to face on phone screen and Transmission of all transmission materials by computer PC, laptop of Internet connection will save us time to be much convenient.

### CROSS-REFERENCE TO RELATED APPLICATION

Disclosure Document Deposit Request; Document No.

| | |
|---|---|
| 503813 date Jan 18, 2002 | 553873 date May 24, 2004 |
| 506484 date Mar 4, 2002 | 554180 date May 27, 2004 |

Substitute for U.S. application Ser. No. 09/943932 date Aug. 27, 2001 abandoned

### STATEMENT REGARDING FEDERALLY SPONSORED RESEARCH

“Not Applicable”

### REFERENCE TO A MICROFICHE APPENDIX

“Not Applicable”

### BACKGROUND OF THE INVENTION

Transmission of image in all kinds of Image phones through cable broadcasting transmission & telephone connections, transmission of documents, pictures, data by computer PC, laptop through telephone connection and transmission of facsimile machine, scanning device, video camera, sensor, radar, or equivalents to make up invention devices are:

Transmission of image in Image phone: telephone with screen is connected and equipped with cable through broadcasting transmission & telephone connection; future telephone will be the one with screen display images of caller and call receiver separately on each side letting phone talkers to see each other on the screen during calling, which does not exist today.

Transmission of all transmission materials by computer PC, laptop of Internet connection: written documents, data, pictures which are stored in computer PCs access by code or words will be transmitted to monitors of computer PCs among them both through telephone connections. “Internet banking”; banking statements are stored in computer PCs from bank services access by code or words and newspapers are published on Web pages by access codes both for clients to read on their monitors of computer PCs.

Transmission of scanning device is for scanning data, words, sentences into computer, laptop, word-processor etc, for scanning figures onto calculator screen on automatic calculation and for scanning gas-meter, electric-meter, water-meter, etc transmitting figures to Gas, Electric, Water Co., both using video camera, camera, scanner or equivalents under phone and electric connections or battery.

### BRIEF SUMMARY OF THE INVENTION

Advantages of the invention are to let:

phone callers talking face to face on image screen phone during calling with emotion, movement and business advertisement purpose,

reading documents, newspapers, Internet banking convenience by computer through Internet connection,

scanning accuracy data, words, sentences, paragraphs onto computer, laptop, word-processor replacing manual keyboard,

scanning gas-meter, electric-meter, water-meter by fax device saving time and charges of door to door noting process.

The invention(s) includes process of making, any energy for functioning, transmission of images, Image screen telephones, Image cell phone, cell phones & telephones built with structure of televisions, computer PCs, laptops or equivalents, satellite antennas, cable connectors, telephone connectors, Internet functioning devices, electric wires, camcorders, video cameras, radars, sensors, screens, general telephone devices, phone message recorders, caller ID, electronic directories, clocks, printers, copiers, scanners, others, computer PCs, laptops, facsimile machines, scanning devices, projecting devices, substitutes, necessary parts, accessories, Duo-T1: Image screen telephone, camcorder, video camera, phone screen, telephone with structure of television, computer PC or laptop Duo-T2: Image phone, adjustable video camera, camcorder, wireless remote device, video cassette/CD/DVD recorder, printer, switch, phone screen, telephone with structure of laptop, antenna Duo-T3: Image screen cell phone, cell phone, structure of image phone, antenna, camcorder, video camera, handset with wire or wireless remote device Duo-T4: Hand phone, Image hand phone, structure of Image phone Duo-T5, Duo-T6, Duo-T7: Handsets, with wire or wireless remote, handset fixing with spectacles, ear hearing wireless remote device Duo-T8: Timely call device, electronic timer device, cassette/disk recorders, Image phone, telephone Duo-T9: Speech dial device, Speech reacting system, calculator, word processor Duo-T10: Digital call numbering indicator, counting meter/counter, telephone Duo-T11: Tele-computer, computer PC, laptop, structure of television, cable, hard drive (disk), with/without wireless remote device, Image phone Duo-T12, T13: Transmission of computer PC of Internet connection, Internet functioning device, cable connector, telephone connector Duo-T14: Internet shopping, video camera, computer PC/laptop, Internet functioning device, cable connector, telephone connector Duo-T15: Transmission scanning device for computer PC/laptop, scanning handle device(s) with lighting, computer PC, laptop, word-processor, telephone, fax machine Duo-T16: Transmission scanning device for calculator, Video camera, scanning handle device with lighting, calculator of all functions, adaptable calculator Duo-T17: Transmission of facsimile machine connecting scanning device, facsimile machine or equivalent device, video camera, computer PC, laptop, Internet functioning device, cable connector, telephone connector Duo-T18: Transmission of facsimile machine connecting device for switching electricity, facsimile machine or equivalent, specific resident's receiving device having structure of facsimile machine, mini motor, conducting box, electric wires, direct electric connection, telephone connector and “no enter sign”, sensors, lamp, wireless remote control, switches.

### BRIEF DESCRIPTION OF THE DRAWINGS

FIG. 1: Duo-T1 Structure of Image screen telephone

FIG. 2: Duo-T2 Image phones

FIG. 3: Video camera

FIG. 4: Antenna satellite

FIG. 5: Duo-T18 Transmission device for switching electricity

FIG. 6: Duo-T3 Image cell phone

FIG. 7: Duo-T4 Hand (Image) phone

FIG. 8: Duo-T5 Handsets

FIG. 9: Duo-T6 Handsets

FIG. 10: Duo-T7 Wireless remote Handsets

FIG. 11: Duo-T17 Function of fax device

### DETAILED DESCRIPTION OF THE INVENTION

Transmission of image in Image screen telephone: Telephone is built with structure of television, monitor computer PC or laptop, or a combination of telephone and television, monitor computer PC, laptop or equivalent for transmitting images of phone users on screens through connected cable broadcasting transmission and telephone line. Transmission image comprises all images with/without movement transmitted on screen of Image phone, comprising:

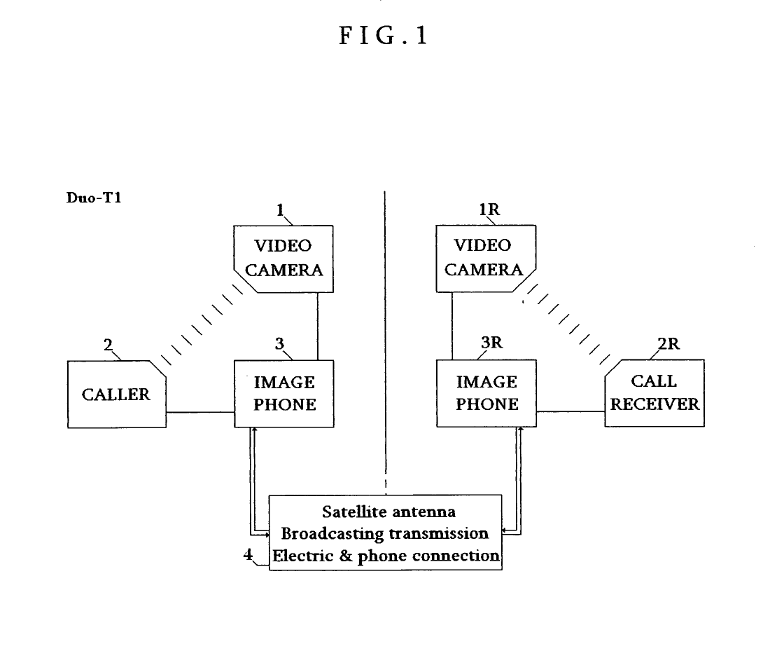

FIG. 1; Duo-T1 Image screen telephone structure: either camcorder 1 or video camera is connected and equipped at Image phone for viewing phone caller 2 to transmit caller's image onto phone screen 3R of phone receiver's side while the other camcorder/video camera 1R is connected and equipped at Image phone for viewing phone receiver 2R to transmit receiver's image onto phone screen 3 of caller's side both by connected cable satellite antenna transmission 4 (FIG. 1 & 4) and telephone line 4 to enjoy image appearance respectively that Image phone lets phone caller and phone receiver seeing each other on phone screen during calling, projecting device or same is connected for showing proper image on proper screen corner of user's Image phone as desirable.

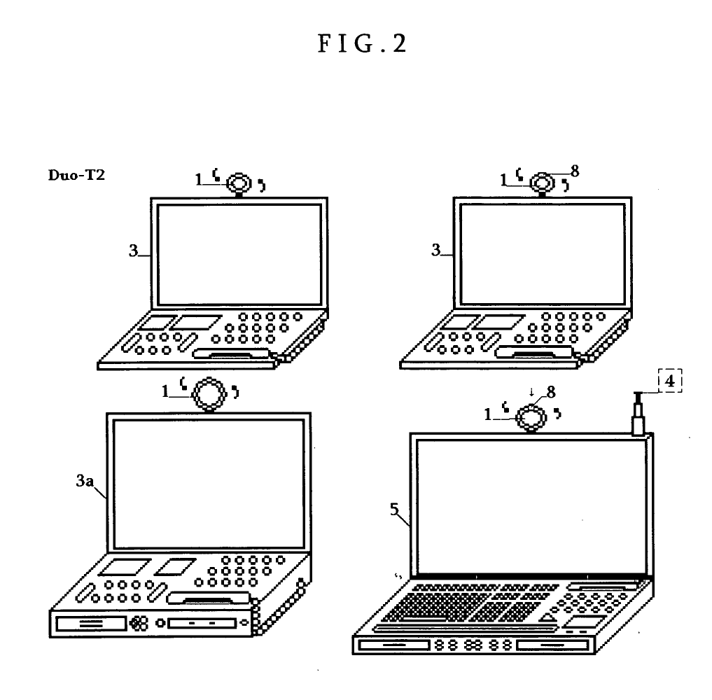

FIG. 2; Duo-T2 Image display phone: adjustable camcorder 1 or video camera is connected and installed at Image display phone 3 with wireless remote device 8. Image phone 3a has video cassette or/CD disk recorder for recording conversation image during calling, a printer is for printing image. There is a switch for turning video camera system off if one does not want to show image on other phone screen, Image phone will be equipped with laptop 5 and antenna 4, wireless remote device 8.

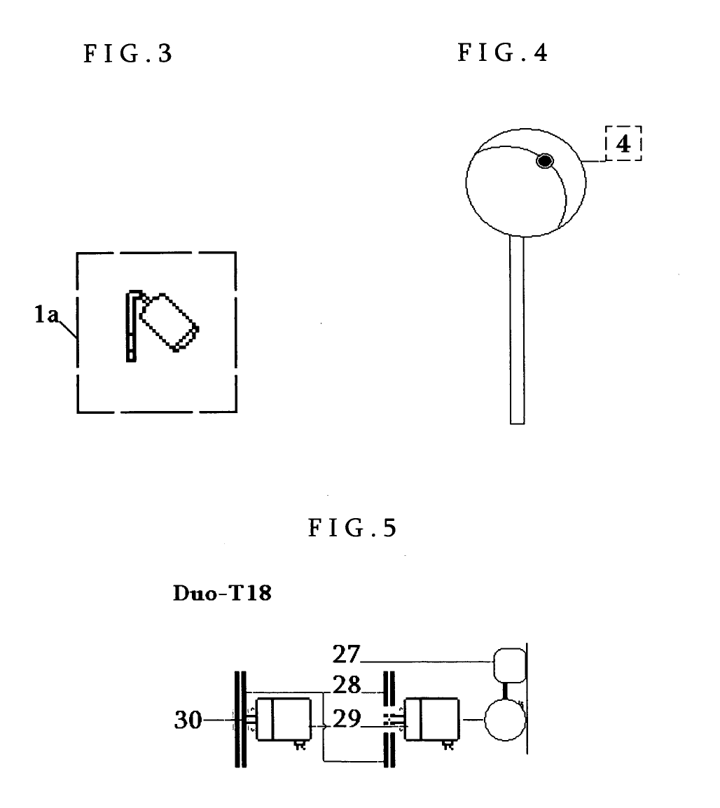

FIG. 3; Automatic transmitting & reacting: either video camera 1a for recording or camera for photographing is connected and installed to Image phone for observing any area, surroundings of house, of building, territory boundary, installed radar or sensor stands by and reacts to function based detected result against approaching persons, obstruction image is transmitted on the screen.

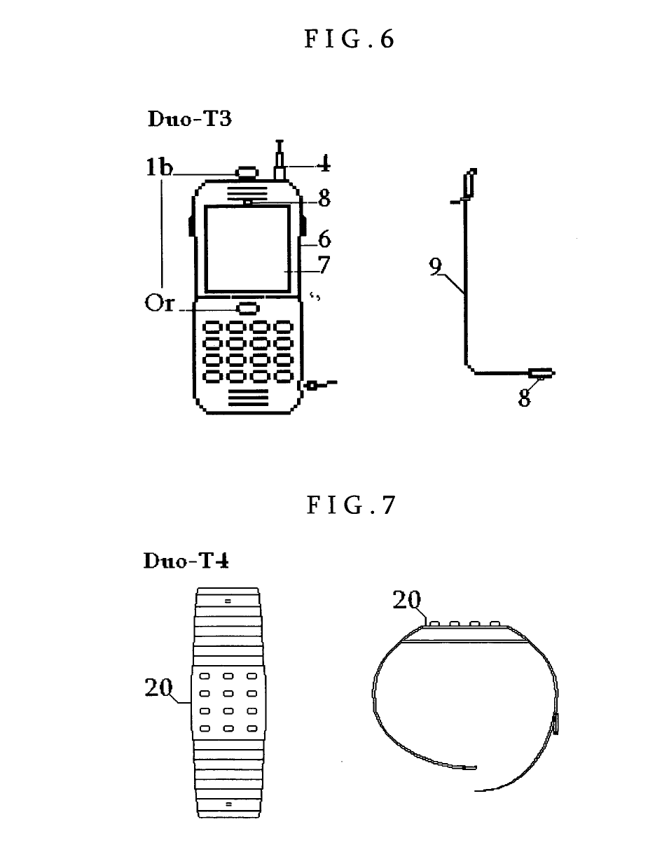

FIG. 6; Duo-T3 Image screen cell phone: cell phone 6 is manufactured with image display screen 7 antenna 4, camcorder/video camera 1b and handset 9 with wire or wireless remote device 8. FIG. 7; Duo-T4 Hand phone: hand phone 20 is manufactured as small as a watch attaching on hand.

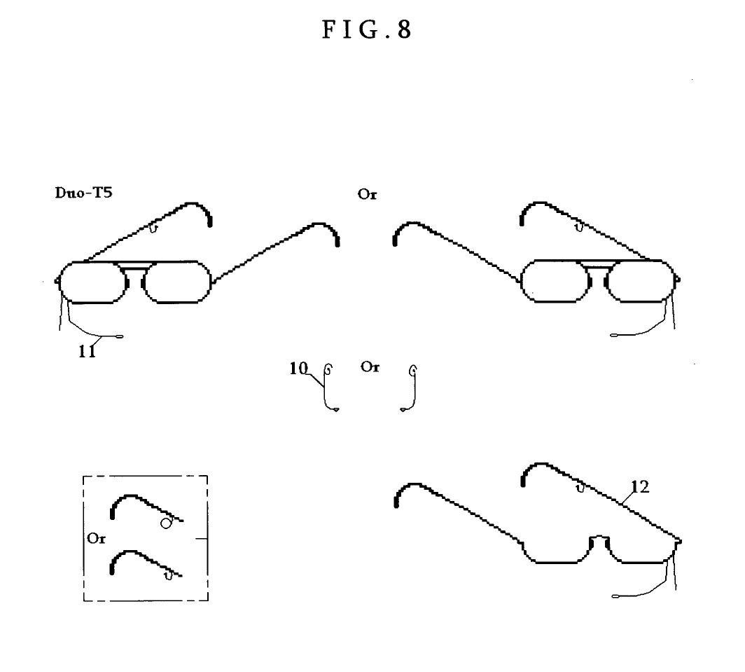

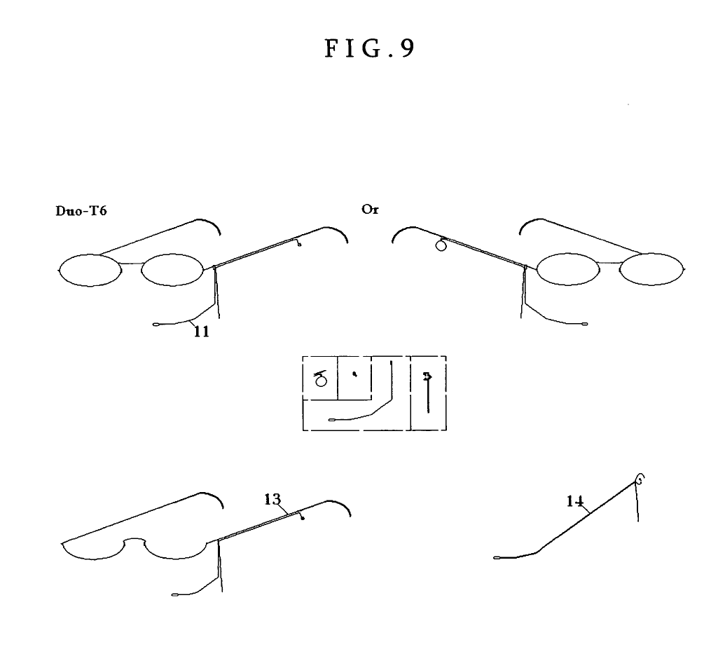

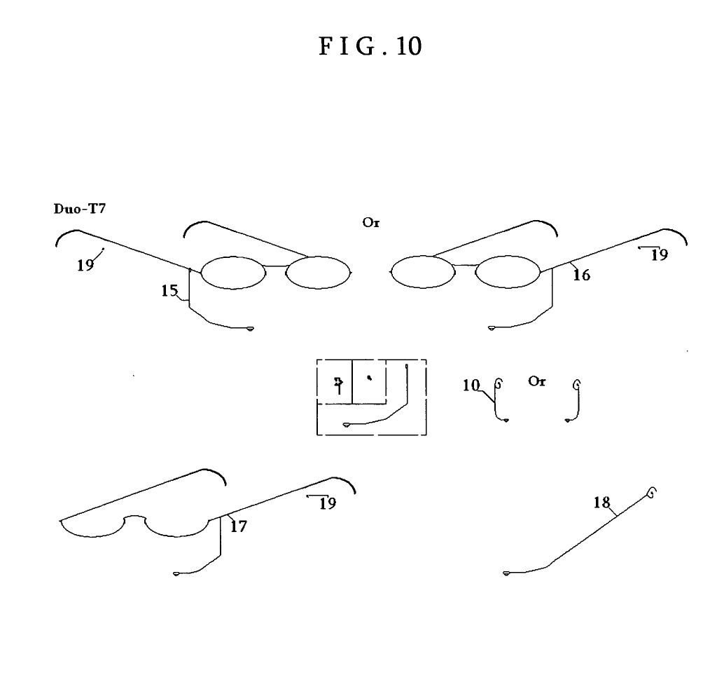

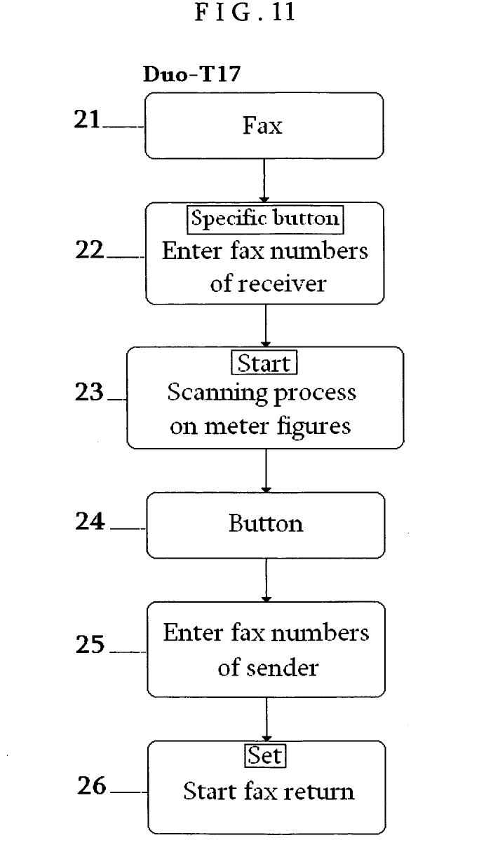

FIG. 8; Duo-T5, FIG. 9: Duo-T6, FIG. 10; Duo-T7: Handsets: a number of handsets are used for Image display phone with wire or wireless remote system as handset 11 fixing with spectacles, handsets 12, 13, 14, wireless remote handset 10, wireless remote handsets 15 to 18 and ear hearing wireless remote device 19.

Duo-T8 Timely call device: electronic timer is equipped therein connecting to call timely and speak recorded messages one after another, calling messages and time settings are recorded earlier to recorder of cassette, disk or equivalents in Image display phone or telephone, both phones ring by (soft) music, recorded preferable voice, etc.

Duo-T9 Speech dial device: it is a system for dialing by speech in place of dialing by finger as a lamp turning on or off by sound. Speech reacting system will further be developed in calculator, word processor etc replacing finger operation.

Duo-T10 Digital call numbering indicator: counting meter or counter is installed in all kinds of telephones for adding up your call each time being connected. Image display phone can well be added with all general telephone systems; phone message recorder, caller ID, electronic directory, clock, fax, printer, scanner, etc.

Duo-T11 Tele-computer; computer PC, laptop are made with structure of television having capability using as either computer PC, laptop or television connected with transmission cable and electric connections or battery, hard drive (disk) is equipped for recording television programs with/without wireless remote device, Image phone, Image cell phone or telephone.

Transmission of documents, pictures, data by computer PC, laptop and transmission of facsimile machine, scanning device, video camera, sensor, or equivalents to materialize invention devices through connected Internet telephone lines and/or cable transmission, comprising:

Transmission of Internet includes Internet facilities, Internet services, Internet connections, any other Internet functions, Internet functioning devices with telephone and/or cable connectors having capability to connect and function Internet connection effect used for and/or installed in computer PCs, laptops, equivalents, all appliances, others to that effect.

Duo-T12 Transmission of computer PC of Internet connection: written documents, pictures, all transmission materials in computer PCs, laptops or equivalents are transmitted to monitors of computer PCs, laptops or equivalents among them between senders and receivers in which transmission materials are stored in computer PCs, laptops or equivalents to be shown up on other monitors of computer PCs, laptops or equivalents by access on code or words both through connected Internet telephone lines and/or cable transmission.

Duo-T13 Internet banking: banking statements, newspapers, all transmission materials are entered in computer PCs, laptops or equivalents from bank services, publishers, companies that clients may read material contents on their monitors of computer PCs, laptops or equivalents by access on code or words through connected Internet telephone lines and/or cable transmission.

Duo-T14 Internet shopping: video cameras are connected and installed against merchandise on shopping centers, supermarkets, stores, shops or equivalents letting clients by access on code or words shopping on their monitors of computer PCs, laptops or equivalents through connected Internet telephone lines and/or cable transmission.

Duo-T15 Transmission scanning device for computer PC, laptop; scanning handle device(s) with lighting or equivalent is for scanning data, words, sentences even paragraphs accurately from document onto electronically connected computer PC, laptop, word-processor or equivalents and scanning handle device with lighting is for scanning phone numbers onto electronically connected telephone, fax machine etc to dial.

Duo-T16 Transmission scanning device for calculator: video camera, scanning handle device with lighting or equivalent is for scanning figures onto electronically connected calculator for either automatic calculation on scanning or setting button to enter figure each time substituting finger operation, it has general operations; buttons of addition, subtraction, multiplication, division, etc functioned by battery or electricity, or using scanning handle device for any adaptable calculator to that effect.

FIG. 11; Duo-T17 Transmission using facsimile machine scanning meters of gas, electricity, water: (1) facsimile machine or similar structure device is connected and installed having scanning device, video camera or equivalent against gas-meter, electric-meter, water-meter or others for scanning figures or other images elsewhere (2) that figure information is transmitted to facsimile machine of Gas, Electric, Water companies under command; (a) sender sets “fax” 21 specific button to enter resident's fax numbers 22 then presses “Start” 23 button on fax machine connecting to resident's receiving device for scanning meter FIGS. 23 of gas, electricity or water recording, (b) sender sets “button” 24 to enter his own fax numbers 25 and presses button “Set/start” 26 on facsimile machine so figure information from resident's device is faxed back to sender(s) of Gas, Electric, Water companies under telephone line & electric connections including receiving information, images and others, using equally computer PC, laptop or equivalent transmitting by Internet phone line and cable connections to that effect.

FIG. 5: Duo-T18 Transmission of facsimile machine connecting device for switching electricity: sender's facsimile machine or equivalent is connected to a specific resident's receiving device having structure of facsimile machine which reacts mini motor 29 or equivalent installed between electric meter 27 and house incoming wires to rotate its conducting box 30 to connect or disconnect electric wires 28 under telephone line & direct electric connections that electric company sets “fax” particular button to enter receiver's fax numbers then presses “Start” button on facsimile machine to operate, both for rotating valves of gas, water, others in similar manner.

Transmission of sensor reacting on traffic sign or elsewhere; sensor reacts by approaching vehicle transmitting to turn on lamp(s) having its beam flashing at level for reacting function of automatic braking device of motor vehicle stopping entering, sensor & lamp are so connected and installed on “no enter sign” or elsewhere.

Transmission of sensor upon wireless remote control; wireless remote control reacts against sensor(s) which transmits to turn on or off under electric connection as a switch for sensor on lamp, sensors as electric switches of wall, others excluding those of garage door and television.

1. What I claim as my invention is: Transmission of image in (image) telephones including Image phone, Image cell phone; either camcorder or video camera connected and equipped to Image screen telephone; telephone built with structure of television, computer PC or laptop, or a combination of telephone and television, computer PC, laptop or equivalent for transmitting images of phone users onto each phone screen seeing each other during calling through connected cable broadcasting transmission, satellite antenna, telephone line and/or by satellite broadcasting transmission or equivalents for Image cell phone, including:
Duo-T1 Image screen phone: either camcorder or video camera being connected and equipped to Image phone for viewing phone caller to transmit caller's image onto phone screen of phone receiver's side by installed cable satellite antenna while the other camcorder or video camera connected and equipped at Image phone for viewing phone receiver to transmit receiver's image onto phone screen of caller's side by installed cable satellite antenna during calling both under telephone connections, projecting device or same connected for showing proper image on proper screen corner of user's Image phone as desirable,
Duo-T2 Image (display) phone: adjustable camcorder or video camera being connected and equipped to Image phone having wireless remote device, video cassette/CD/DVD disk recorder for recording conversation image, printer for printing image, a switch connected for turning off video camera system if undesirable image be shown on other phone screen, Image phone equipped with laptop, antenna, wireless remote device, or others,
transmission image comprising image with/without movement transmitted on screen; appearance of transmitted moving person image, appearance of transmitted person, of transmitted picture and/or any other similar appearance transmitted on screen in connected Image phone,
transmission; either video camera/camcorder for recording or camera for photographing connected and installed to Image phone for observing any area, surroundings of house, of building, territory boundary, installed radar or sensor standing by and reacting automatically to function based detected result against approaching persons, obstruction image transmitted on the screen,
Duo-T3 Image screen cell phone: cell phone manufactured with image screen, camcorder/video camera, camera, handset, antenna, with wire or wireless remote device, Duo-T4 Hand phone: hand phone including Image screen hand phone, cell phone manufactured as small as a watch attaching on hand,
Duo-T5, Duo-T6, Duo-T7 Handsets: handsets with wire or wireless remote device as handset fixing with spectacles, spectacles handsets and ear hearing wireless remote device for telephones including Image phone, Image cell phone, cell phone,
Duo-T8 Timely call device; calling messages, phone numbers and time settings being recorded earlier into installed recorder of cassette, disk or equivalents for telephones including Image phone, Image cell phone, cell phone connecting to call timely and speak recorded messages one after another, all telephones ringing by music, recorded preferable sounding, human or animal voice,
Duo-T9 Speech dial device: dialing by speech in place of dialing by finger in all kinds of telephones as a lamp turning on or off by sound, speech reacting device be further developed in calculator, word processor, etc replacing finger operation,
Duo-T10 Digital call numbering indicator: counting meter or counter installed in an kinds of telephones, cell phones including Image phone, Image cell phone for adding up your call each time being connected, Image phone be added with all general telephone devices; answering phone recorder, caller ID, electronic directory, clock, printer, fax machine, copier, scanner as desirable,
Duo-T11 Tele-computer; computer PC, laptop made with structure of television having capability using as either computer PC, laptop or television connected with transmission cable, hard drive (disk) installed for recording television programs with/without wireless remote device, Image phone, Image cell phone or telephone.

2. What I claim as my invention is: Transmission of written materials, documents, pictures, data, books, directories, catalogs, magazines, newspapers, music, movies and all transmission materials transmitted by computer PC, laptop or equivalents through connected Internet telephone line, cable satellite antenna or equivalents including transmission using facsimile machine, scanning device, video camera, sensor, or equivalents transmitted to materialize invention devices, comprising:
transmission of Internet including Internet facilities, Internet services, Internet connections, any other Internet functions, Internet functioning devices with telephone and/or cable connectors having capability to connect and function Internet connection effect used for and/or installed in computer PCs, laptops, equivalents, all appliances, others to that effect,
Duo-T12 Transmission by computer PC of Internet connection: written documents, pictures, all transmission materials in computer PCs, laptops or equivalents transmitted to monitors of computer PCs, laptops or equivalents among them between senders and receivers in which transmission materials stored in computer PCs, laptops or equivalents to be shown up on other monitors of computer PCs, laptops or equivalents by access on code or words both through connected Internet telephone lines and/or cable transmission,
Duo-T13 Internet banking: banking statements, newspapers, all transmission materials entered in computer PC, laptop or equivalents from bank services, publishers, companies for clients to read material contents on their monitors of computer PCs, laptops or equivalents by access on code or words through connected Internet telephone lines and/or cable transmissions,
Duo-T14 Internet shopping: video cameras connected and installed against merchandise on shopping centers, supermarkets, stores, shops or equivalents letting clients by access on code or words shopping on their monitors of computer PCs, laptops or equivalents through connected Internet telephone line and/or cable transmission,
Duo-T15 Transmission scanning device for computer PC, laptop; scanning handle device(s) with lighting or equivalents for scanning data, words, sentences, paragraphs from document onto connected computer PC, laptop, word-processor or equivalents and for scanning phone numbers onto connected telephone, fax machine or equivalents,
Duo-T16 Transmission scanning device for calculator: video camera, scanning handle device with lighting or equivalents for scanning figures onto connected calculator having general calculating operations for either automatic calculation on scanning or setting button each time to enter figures, or using scanning handle connected for any adaptable calculator,
Duo-T17 Transmission using facsimile machine scanning meters of gas, electricity, water: (1) facsimile machine or similar structure device connected and installed having scanning device, video camera or equivalent against gas-meter, electric-meter, water-meter or others for scanning figures or other images elsewhere (2) that figure information being transmitted to facsimile machines of Gas, Electric, Water companies under command; (a) sender setting “fax” specific button to enter resident's fax numbers then pressing “Start” button on fax machine connecting to resident's receiving device for scanning meter figures of gas, electricity or water recording, (b) sender setting “button” to enter his own fax numbers, pressing button “Set/start” on facsimile machine so figure information from resident's device being faxed back to sender(s) of Gas, Electric, Water companies under telephone line & electric connections including receiving information, images and others, using equally computer PC, laptop or equivalent transmitting by Internet phone line and cable connections to that effect,
Duo-T18 Transmission of facsimile machine connecting device for switching electricity: sender's facsimile machine or equivalent connecting to specific resident's receiving device having structure of facsimile machine which reacting mini motor or equivalent installed between electric meter and house incoming wires to rotate its conducting box for connecting or disconnecting electric wires under telephone line and direct electric connection that electric company setting “fax” particular button to enter receiver's fax numbers then pressing “Start” button on facsimile machine to operate, both for rotating valves of gas, water in similar manner,
transmission of sensor reacting on traffic sign, elsewhere; sensor reacting by approaching vehicle transmitting to turn on lamp(s) having its beam flashing at level for reacting function of automatic braking device of motor vehicle stopping entering, sensor & lamp so connected and installed on “no enter sign” or elsewhere,
transmission of sensor upon wireless remote control; wireless remote control reacting against sensor(s) which transmitting for turning on or off under electric connection as a switch for sensor on lamp, sensors as electric switches of wall excluding those of garage door and television.

3. What I claim as my invention is: Invention(s) in these documents includes the original elements, composition, connection, operation, function, structures, illustrations, process of making, production, installation, combination, necessary parts, any energy for functioning, network and using of the invention, any other structures, modifications, facilities, services, imitations, substitutes, replacement of parts being assembled for performing the same or similar formation based fundamentals on the invention(s) in these documents functioning to the same effect, combining the invention(s) with any other machineries, portable telephones, all kinds of phones, devices, instruments, equipments, appliances, systems, objects, others functioning to the same or similar outcome under any names being in the scope of protection of the invention, using the invention at residences, offices, everywhere, installing them in automobiles, cars, trains, trucks, buses, vans, trolleys, underground trains, tanks, motor & engine vehicles, motorcycles, airplanes, ships, submarines, helicopters, fleet, appliances, all transportations.
